(19) United States
(12) Patent Application Publication
(10) Pub. No.: US 2007/0042132 A1
(43) Pub. Date: Feb. 22, 2007

(54) Method of forming plasma and method of forming a layer using the same

(76) Inventors: Jung-Hun Seo, Suwon-si (KR); Young-Wook Park, Suwon-si (KR); JIn-Gi Hong, Suwon-si (KR); Kyung-Bum Koo, Yongin-si (KR); Eun-Taeck Lee, Suwon-si (KR); Yun-Ho Choi, Yongin-si (KR)

Correspondence Address: HARNESS, DICKEY & PIERCE, P.L.C., P.O. BOX 8910, RESTON, VA, 20195, US

(21) Appl. No.: 11/450,455

(22) Filed: Jun. 12, 2006

(30) Foreign Application Priority Data
Jun. 13, 2005 (KR) 2005-0050168

(51) Int. Cl. H05H 1/24; C03C 15/00

(52) U.S. Cl. 427/569; 216/67

(57) ABSTRACT

A method of forming plasma used in a process of manufacturing a semiconductor device and a method of forming a layer for a semiconductor device using the plasma are disclosed. The plasma forming method includes forming a plasma region in a sealed space by supplying a plasma source gas into the sealed space at a first flow rate and maintaining the plasma region by supplying a plasma maintenance gas into the sealed space at a second flow rate higher than the first flow rate. The plasma source gas includes a first gas having a first atomic weight, and the plasma maintenance gas includes a second gas having a second atomic weight lower than the first atomic weight. The plasma source gas includes argon and the plasma maintenance gas includes helium. The method may further include forming the layer on a wafer by supplying a source gas into the sealed space.

### PRIORITY STATEMENT

This application claims priority under 35 USC §119 to Korean Patent Application No. 2005-50168 filed on Jun. 13, 2005, the contents of which are herein incorporated by reference in their entirety.

### BACKGROUND

1. Field of the Invention

Example embodiments of the present invention relate to a method of manufacturing a semiconductor device. More particularly, example embodiments of the present invention relate to a method of forming plasma used in a process of manufacturing a semiconductor device and a method of forming a layer for a semiconductor device using the plasma.

2. Description of the Related Art

In general, manufacturing a semiconductor device includes a fabrication process, an electric die sorting (EDS) process, and a package assembly process. In the fabrication process, the semiconductor device is formed on a silicon wafer, and may include electrical circuits. In the electrical die sorting (EDS) process, electrical characteristics of the semiconductor devices formed in the fabrication process are inspected. In the package assembly process, each of the semiconductor devices is packaged by applying an epoxy resin to the semiconductor devices formed on the silicon wafer and then cutting the epoxy resin to separate individual semiconductor packages.

The fabrication process may include a deposition process for forming a layer on the wafer, a chemical mechanical polishing process for planarizing the layer, a photolithography process for forming a photoresist pattern on the layer, an etching process for etching the layer to form a pattern having electric characteristics using the photoresist pattern as an etching mask, an ion implantation process for implanting ions into a given region of the wafer, a cleaning process for removing contaminants from the wafer, and/or an inspection process for inspecting a surface of the wafer on which the layer or the pattern is formed.

Modern semiconductor devices are being widely and rapidly developed for uses relating to information media. Such semiconductor devices may be required to operate at higher speeds and/or have higher storage capacities. Therefore, semiconductor devices are becoming increasingly integrated. To meet these requirements, semiconductor device manufacturers have begun employing plasma in order to increase process accuracy in the manufacturing process, for example, the accuracy of the deposition process, the etching process and/or the cleaning process, and the process accuracy has been improved through the use of plasma.

Plasma is generated either by an in-situ process or by a remote process. In the in-situ process, plasma is generated in a chamber. Thereafter, a semiconductor device manufacturing process is performed in the same chamber. Unfortunately, the formation of plasma directly in a chamber may damage any wafer already within the chamber, an inner wall of the chamber, or any other exposed surface. Alternatively, in the remote process, plasma is generated outside of a semiconductor manufacturing chamber and is then supplied into the chamber.

The related art has attempted to address the damage caused by the formation of plasma in the semiconductor manufacturing chamber. In one such method, a process gas is introduced into a chamber via a gas supply unit of the chamber, and an inert gas such as helium gas, neon gas, argon gas, krypton gas, xenon gas or radon gas is also supplied into the chamber via the gas supply unit. The process gas and the inert gas are mixed with each other in the chamber to form a mixture gas. The above method may prevent defects in a formed semiconductor device layer caused by argon gas and plasma.

However, plasma damage to the wafer may still occur in the chamber even though plasma is generated using the mixture gas.

### SUMMARY OF THE INVENTION

Example embodiments of the present invention provide a method of forming plasma, wherein plasma damage may be reduced while manufacturing a semiconductor device using plasma.

Example embodiments of the present invention provide a method of forming a layer using plasma formed by the method of forming plasma, wherein the plasma damage may be reduced while manufacturing the semiconductor device using plasma.

An example embodiment of the present invention is directed to a method of forming plasma. In the method of forming plasma, a plasma region is formed in a sealed space by supplying a plasma source gas into the sealed space at a first flow rate. The plasma source gas includes a first gas having a first atomic weight. The plasma region is maintained by supplying a plasma maintenance gas into the sealed space at a second flow rate higher than the first flow rate. The plasma maintenance gas includes a second gas having a second atomic weight lower than the first atomic weight.

In an example embodiment of the present invention, the first gas may include neon, argon, krypton, xenon or radon, and the second gas may include helium, neon, argon, krypton or xenon such that the first and the second gases are different from each other.

In an example embodiment of the present invention, the plasma maintenance gas may further include a third gas substantially the same as the first gas.

In an example embodiment of the present invention, the plasma maintenance gas may further include a third gas that is different from the first gas and has a third atomic weight lower than the first atomic weight of the first gas. The third gas may include helium, neon, argon, krypton or xenon.

In an example embodiment of the present invention, the plasma maintenance gas may further include a fourth gas substantially the same as the first gas.

In an example embodiment of the present invention, the plasma source gas may further include a third gas substantially the same as the second gas.

In an example embodiment of the present invention, the plasma source gas may further include a third gas that is different from the second gas and has a third atomic weight higher than the second atomic weight of the second gas. The third gas may include neon, argon, krypton, xenon or radon.

In an example embodiment of the present invention, the plasma source gas may further include a fourth gas substantially the same as the second gas.

In an example embodiment of the present invention, the plasma source gas may further include a third gas that is substantially the same as the second gas or has a third atomic weight higher than that of the second gas, and may include helium, neon, argon, krypton, xenon or radon. The plasma maintenance gas may further include a fourth gas that is substantially the same as the first gas or has a fourth atomic weight lower than the first atomic weight of the first gas, and may include helium, neon, argon, krypton, xenon or radon.

In an example embodiment of the present invention, the plasma source gas includes a first mixture gas and the plasma maintenance gas includes a second mixture gas, and the first and the second mixture gases may include substantially the same components therein at respective mixture ratios different from each other.

In an example embodiment of the present invention, the plasma source gas may include the second gas more than the plasma maintenance gas.

In an example embodiment of the present invention, a flow rate ratio of the first flow rate to the second flow rate may be in a range of approximately 1:1.1 to approximately 1:2.

In an example embodiment of the present invention, the method of forming plasma may further comprise supplying a source gas for a wafer processing into the sealed space.

In an example embodiment of the present invention, the source gas for the wafer processing may be supplied at the same time as the plasma source gas is supplied.

In an example embodiment of the present invention, the source gas for the wafer processing may be supplied at the same time as the plasma region is formed.

In an example embodiment of the present invention, the source gas for the wafer processing may be supplied in a state in which the plasma region is maintained.

In an example embodiment of the present invention, the source gas for the wafer processing may include an etching gas for etching a layer formed on a wafer.

In an example embodiment of the present invention, the source gas for the wafer processing may be a deposition gas for forming a layer on a wafer by a deposition process.

In an example embodiment of the present invention, the source gas for the wafer processing may be a cleaning gas for removing contaminants from a wafer.

In an example embodiment of the present invention, energy applied into the sealed space while forming the plasma region may be substantially equal to energy applied into the sealed space while maintaining the plasma region.

In an example embodiment of the present invention, energy applied into the sealed space while forming the plasma region may be lower than energy applied into the sealed space while maintaining the plasma region.

According to another example embodiment of the present invention, there is a method of forming a layer. In the method of forming the layer, a plasma region is formed in a sealed space by supplying a first gas including argon into the sealed space with a first flow rate. The plasma region is maintained by supplying a second gas including helium into the sealed space with a second flow rate higher than the first flow rate. A layer is formed on a wafer by supplying a source gas into the sealed space.

In an example embodiment of the present invention, the second gas may further comprise argon.

In an example embodiment of the present invention, the first gas may further comprise helium.

In an example embodiment of the present invention, the first gas may further comprise helium, and the second gas may further comprise argon.

In an example embodiment of the present invention, helium may be included in the second gas more than in the first gas.

In an example embodiment of the present invention, a flow rate ratio of the first gas to the second gas may range from approximately 1:1.1 to approximately 1:2.

In an example embodiment of the present invention, the source gas may include titanium tetrachloride (TiCl₄) gas and hydrogen (H₂) gas.

In an example embodiment of the present invention, a flow rate ratio of titanium tetrachloride (TiCl₄) gas to hydrogen (H₂) gas may range from approximately 1:300 to approximately 1:400.

In an example embodiment of the present invention, energy applied into the sealed space while forming the plasma region may be substantially equal to energy applied into the sealed space while maintaining the plasma region.

In an example embodiment of the present invention, energy applied into the sealed space while forming the plasma region may be lower than energy applied into the sealed space while maintaining the plasma region.

In an example embodiment of the present invention, the method of forming the layer may further comprise nitriding the layer formed on the wafer by supplying a gas including nitrogen to the sealed space.

According to example embodiments of the present invention, the plasma region may be formed using the first gas of which an ionization energy is relatively low. Therefore, damage to the wafer caused by plasma in the formation of the plasma region may be reduced; thus, the wafer may be spared the damage caused by plasma because most of the damage to the wafer by plasma is caused in the formation of the plasma region. Additionally, the plasma region is maintained using the second gas, of which mobility is relatively high, so that the plasma region may be uniformly maintained.

### BRIEF DESCRIPTION OF THE DRAWINGS

The above and other features and advantages of example embodiments of the present invention will become more apparent by describing in detailed example embodiments thereof with reference to the accompanying drawings, in which:

FIG. 1 is a cross-sectional view illustrating a wafer processing apparatus using plasma, in accordance with an example embodiment of the present invention;

FIG. 2 is a process flow chart illustrating a method of forming plasma in accordance with an example embodiment of the present invention;

FIG. 3 is a process flow chart illustrating a method of forming a layer in accordance with another example embodiment of the present invention; and

FIGS. 4 and 5 are cross-sectional views illustrating a method of a double layer including a titanium layer and a titanium nitride layer, in accordance with an example embodiment of the present invention.

### DETAILED DESCRIPTION OF EXAMPLE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

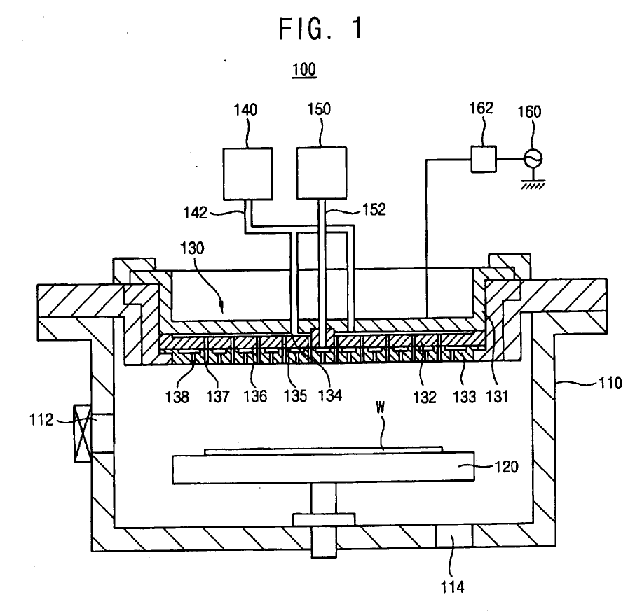

FIG. 1 is a cross-sectional view illustrating a wafer processing apparatus using plasma, in accordance with an example embodiment of the present invention.

Referring to FIG. 1, a wafer processing apparatus 100 may include a chamber 110, a stage 120, a showerhead 130, a first gas source 140, a second gas source 150, and a high-frequency power source 160.

The chamber 110 may have a cylindrical or box shape. The chamber 110 may have a wafer loading gate 112 located at a sidewall through which a wafer (W) is loaded into the chamber 110. A lower portion of the chamber 110 may include an exhaust gate 114, through which an internal gas is discharged out of the chamber 110. The exhaust gate 114 may be connected to an exhaust unit (not shown), for example, a pump. When the exhaust unit is operated, the internal gas in the chamber 110 may be discharged through the exhaust gate 114, which may cause an inner pressure of the chamber 110 to achieve a desired or predetermined degree of vacuum.

The stage 120 may be positioned in the chamber 110, and support the wafer (W) in a horizontal position. The stage 120 may have an internal heater (not shown). The heater may heat the wafer (W) supported by the stage 120 to a desired or predetermined temperature.

The showerhead 130 may be located at an upper portion of the chamber 110, facing the stage 120. The showerhead 130 may uniformly supply a plasma forming gas and a wafer processing gas.

The showerhead 130 may include an upper plate 131, a central plate 132, and a lower plate 133. In an example embodiment of the present invention, the showerhead 130 may have a cylindrical shape, and a circular shape from a plan view.

The upper plate 131 may include a horizontal portion and a ring-shaped support portion that extends upward from a circumferential edge of the horizontal portion. In an example embodiment of the present invention, the upper plate 131 may have a hollow disk shape, for example, the horizontal portion and the support portion together may form a hollow space over the horizontal portion.

The central plate 132 may also have a circular shape from a plan view similar to the upper plate 131. A top surface of the central plate 132 may be partially recessed except for a circumferential edge, so as to form a first space 134 between a bottom surface of the upper plate 131 and the top surface of the central plate 132 when the upper plate 131 and the central plate 132 are stacked. The central plate 132 may have a plurality of first holes 135 through the central plate 132 and may provide a channel from the first space 134 into the chamber.

The lower plate 133 may have a circular shape from a plan view. A plurality of grooves 136 may be uniformly arranged on a top surface of the lower plate 133 in a radial direction, and a plurality of second holes 138 may be formed at each of the grooves 136. The second holes 138 may be through the lower plate 133. When the central and the lower plates, 132 and 133, are combined with each other, a second space may be formed between a bottom surface of the central plate 132 and a top surface of the lower plate 133. The second holes 138 may provide a channel from the second space into the chamber, and the grooves 136 and the second holes 138 may provide a first path through which a processing gas may pass into the chamber 110.

A plurality of third holes 137 in the lower plate 133 may be arranged at the lower plate 133 between the grooves 136. When the central and lower plates, 132 and 133, are combined with each other, the third holes 137 may align with the first holes 135 of the central plate 132, and the first and the third holes, 135 and 137, may provide a second path through which another processing gas may pass into the chamber 110.

A first inert gas for forming plasma or a first source gas for processing the wafer (W) may be supplied to the chamber 110 from the first gas source 140, through a first supply line 142 connected to the space 134. The first inert gas or the first source gas may be supplied into the chamber 110 from the first gas source 140 through the first supply line 142 and the second path.

A second inert gas for forming plasma or a second source gas for processing the wafer (W) may be supplied to the chamber 110 from the second gas source 150 through a second supply line 152 connected to the grooves 136. The second inert gas or the second source gas may be supplied into the chamber 110 from the second gas source 150, through the second supply line 152 and the first path.

A high-frequency power source 160 may be used as an energy source for generating plasma. For example, a microwave may be used as the high-frequency power source 160. The high-frequency power source 160 applies high-frequency power to the showerhead 130, so that the first and the second inert gases achieve a plasma state. In an example embodiment of the present invention, the high-frequency power source 160 may be connected to the upper plate 131 of the showerhead 130, and apply the high-frequency power through an adapter 162. The high-frequency power applied to the showerhead 130 may be stable or variable in accordance with process conditions.

In an example embodiment of the present invention, the high-frequency power source 160 may provide the energy source. Alternatively, a direct current (DC) source may be used as the energy source for generating plasma. Further, a microwave may be used as the energy source for generating plasma.

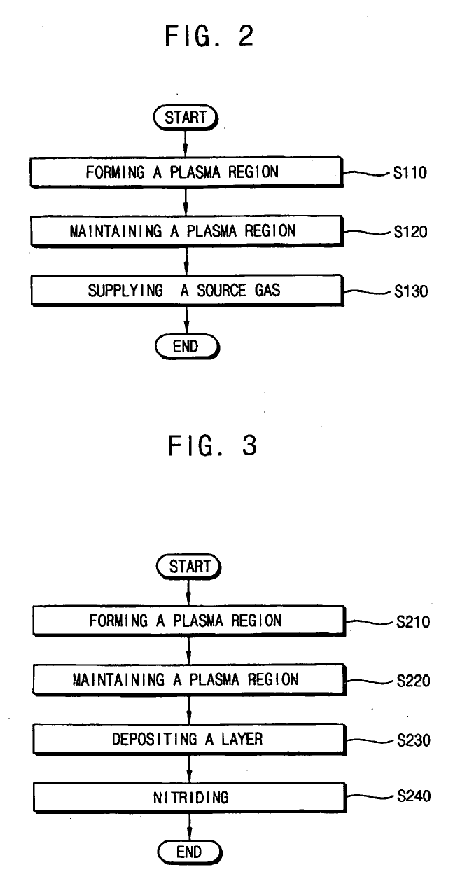

FIG. 2 is a process flow chart illustrating a method of forming plasma in accordance with an example embodiment of the present invention.

Referring to FIGS. 1 and 2, the first gas source 140 may supply a first gas via the showerhead 130 into the chamber 110 at a first flow rate. The chamber 110 may be sealed so that the inside of the chamber 110 may provide a sealed space. An inert gas may be used as the first gas, for example, helium gas, neon gas, argon gas, krypton gas, xenon gas, radon gas, etc. These may be used alone or in a mixture. An ionization energy of the inert gas decreases as an atomic weight of the inert gas increases. For example, helium gas has the highest ionization energy and radon gas has the lowest ionization energy. Additionally, mobility of the inert gas increases as the atomic weight of the inert gas decreases. For example, helium gas has the highest mobility and radon gas has the lowest mobility.

In an example embodiment of the present invention, the first gas may include a pure gas, for example, one of neon gas, argon gas, krypton gas, xenon gas, and radon gas. When a pure gas is used as the first gas, helium gas may not be used.

In another example embodiment of the present invention, the first gas may include a mixture gas. For example, the mixture gas may include at least two component gases selected from helium gas, neon gas, argon gas, krypton gas, xenon gas, and radon gas. When the mixture gas is used as the first gas, helium gas may be one of the component gases.

After the first gas is supplied into the chamber 110, the high-frequency power source 160 may apply a first energy to the showerhead 130. When the first pure gas is used as the first gas, the first energy applied to the showerhead 130 may be substantially equal to or higher than an ionization energy of the first pure gas. For example, when argon gas is used as the first gas, the first energy applied to the showerhead 130 may be substantially equal to or higher than 1,520 kJ/mol or 15.75 eV corresponding to the ionization energy of argon gas.

When the first mixture gas is used as the first gas, the first energy applied to the showerhead 130 may be substantially equal to or higher than an ionization energy of a component gas in the first mixture gas having the lowest atomic weight. For example, when the mixture gas includes argon and helium, the first energy applied to the showerhead 130 may be substantially equal to or higher than the ionization energy of helium gas because the atomic weight of helium is lower than that of argon. Therefore, the first energy applied to the showerhead 130 may be substantially equal to or higher than about 2,372 kJ/mol or about 24.6 eV, corresponding to the ionization energy of helium gas. A plasma region may be formed in the chamber 110 by the first energy applied to the showerhead 130 (S110).

The ionization energy of the first gas may be lower than that of a second gas, described later. Thus, the first gas may form the plasma region using less energy than if the plasma region were formed by the second gas. Additionally, because the first gas may have a higher atomic weight than the second gas, the first gas may have less mobility than the second gas. Therefore, wafer (W) damage caused by plasma when using the first gas may be less than when using the second gas. Moreover, the damage to the wafer (W) caused by plasma in the formation of the plasma region may be reduced.

Although example embodiments disclose that the first energy is applied to the showerhead 130 after the first gas is supplied into the chamber 110, the first energy may also be applied to the showerhead prior to or simultaneous with the first gas.

When the plasma region is formed in the chamber 110, the second gas source 150 may supply the second gas via the showerhead 130 into the chamber 110 at a second flow rate. An inert gas may be used as the second gas. When completing the plasma region in the chamber 110, the second gas may be supplied into the chamber 110 through the showerhead 130 from the second gas source 150 at a second flow rate.

The second flow rate of the second gas may be higher than the first flow rate of the first gas. For example, a flow rate ratio of the first gas to the second gas may range from approximately 1.0:1.1 to approximately 1:2. When a layer is formed on the wafer (W) by a depositing process in a non-uniform plasma region, uniformity of the layer may be poor and may create various defects in a subsequent process. In contrast, when the flow rate ratio of the first gas to the second gas is greater than approximately 1:2, the potential damage to the wafer (W) caused by the plasma when using the second gas may be more severe than when using the first gas. Therefore, the overall damage to the wafer (W) may not be sufficiently improved despite the use of the second gas.

In an example embodiment of the present invention, the second gas includes a pure gas. For example, when the pure gas is used as the first gas, the second gas may include one of helium gas, neon gas, argon gas, krypton gas and xenon gas. The second gas may have a lower atomic weight than that of the first gas. Radon gas may not be used as the second gas.

In contrast, when a mixture gas is used as the first gas, the second gas may include one of helium gas, neon gas, argon gas, krypton gas and xenon gas. The atomic weight of the second gas may not exceed the atomic weight of a component gas of the first gas. When the mixture gas is used as the first gas, radon gas may not be used as the second gas like when the pure gas is used as the first gas.

In an example embodiment of the present invention, the second gas may include a mixture gas. When a pure gas is used as the first gas, the second gas may include a mixture gas. The mixture gas may include at least two gases selected from helium gas, neon gas, argon gas, krypton gas, xenon gas and radon gas. A component gas of the second gas, having a lowest atomic weight among the components of the mixture gas, may have an atomic weight less than or substantially equal to that of the first gas. In an example embodiment, even if radon gas is used as the first gas, the second gas may include radon gas.

In contrast, when a mixture gas is used as the first gas, the second gas may include a mixture gas having at least two gases selected from helium gas, neon gas, argon gas, krypton gas, xenon gas and radon gas. A component gas of the second gas may have an atomic weight less than the lowest atomic weight of any component gas of the first gas.

When each of the first and the second gases includes a mixture gas, the second gas may include a first component gas having a lower atomic weight than the lowest atomic weight of a component gas in the first gas, and a second component gas substantially identical to one of the components of the first gas.

In an example embodiment of the present invention, when the first and the second gases include a mixture gas, component gases of the first gas may be substantially the same as those of the second gas. For example, a heavy gas having a relatively high atomic weight may be included in the first gas more than the second gas, and a light gas having a relatively low atomic weight may be included in the second gas more than the first gas.

When the second gas is supplied into the chamber 110 and the first energy is firstly applied to the showerhead 130 to a degree that is substantially equal to or higher than the ionization energy of the second gas, the second gas may achieve a plasma state.

For example, when a pure gas is used as the second gas, the first energy applied to the showerhead 130 may be substantially equal to or higher than the ionization energy of the pure gas. For example, when helium gas is used as the second gas, the first energy applied may be substantially equal to or higher than 2,372 kJ/mol or 24.6 eV, corresponding to the ionization energy of helium gas.

When a mixture gas is used as the second gas, the first energy may be applied to the showerhead 130 to a degree that is substantially equal to or higher than an ionization energy of a component of the gas mixture having the lowest atomic weight. For example, if the second gas includes a mixture gas of argon and helium, the first energy may be substantially equal to or higher than about 2,372 kJ/mol or about 24.6 eV, corresponding to the ionization energy of helium gas which has a lower atomic weight than argon gas.

While the first gas is in the plasma state, the second gas may achieve a plasma state even though the first energy may be lower than the ionization energy of the second gas. Therefore, the first energy applied to the showerhead 130 may be higher than the ionization energy of the first gas and lower than the ionization energy of the second gas.

However, if the first energy applied to the showerhead 130 is substantially equal to or higher than the ionization energy of the first gas, but is lower than the ionization energy of the second gas, the second gas in the chamber 110 may not achieve a plasma state. At this case, the high-frequency power source 160 may apply a second energy substantially equal to or higher than the ionization energy of the second gas to the showerhead 130.

In an example embodiment of the present invention, the second energy may be applied to the showerhead 130 before the second gas is supplied into the chamber 110. In another example embodiment of the present invention, the second energy may be applied to the showerhead 130 at the same time the second gas is supplied into the chamber 110.

When a pure gas is used as the second gas, the second energy applied to the showerhead 130 may be substantially equal to or higher than the ionization energy of the pure gas. For example, when helium gas is used as the second gas, the second energy applied to the showerhead 130 may be higher than the ionization energy of helium gas.

When a mixture gas is used as the second gas, the second energy applied to the showerhead 130 may be substantially equal to or higher than the ionization energy of a gas having the lowest atomic weight in the second gas. For example, when a mixture gas of argon and helium is used as the second gas, the second energy applied to the showerhead 130 may be substantially equal to or higher than the ionization energy of helium gas, which has a lower atomic weight than argon gas.

At S120, the second gas may achieve the plasma state by the first energy applied or the second energy applied to the showerhead 130, and then may maintain the plasma region uniformly.

The ionization energy of the second gas may be higher than that of the first gas. However, the mobility of the second gas may be higher than that of the first gas in forming plasma because the second gas may have a lower atomic weight than the first gas. Therefore, the second gas may maintain the plasma region uniformly.

At 8130, a source gas is supplied to the chamber 110 in which the plasma region is uniformly formed.

The source gas may include an etching gas, a deposition gas, a cleaning gas, etc. An etching gas may be used for etching various layers on the wafer (W), and a deposition gas may be used for forming a layer on the wafer (W). A cleaning gas may be used for cleaning the wafer (W), so as to remove any foreign substances from the wafer (W).

In an example embodiment of the present invention, the source gas and the first gas may be supplied to the chamber 110, simultaneously. In another example embodiment of the present invention, the source gas and the second gas may be supplied to the chamber 110, simultaneously.

Accordingly, the plasma region may be formed in the chamber 110 using the first gas at a relatively low energy. Therefore, damage to the wafer (W) caused by plasma in the formation of the plasma region may be reduced; thus, the wafer (W) may be less likely to be damaged by plasma because most of the damage to the wafer (W) is caused by the formation of the plasma region.

FIG. 3 is a flow chart illustrating processing for a method of forming a layer in accordance with another example embodiment of the present invention.

Referring to FIGS. 1 and 3, the first gas source 140 may supply a third gas including argon gas via the showerhead 130 into the chamber 110. Argon gas is an inert gas, and an ionization energy of argon gas is lower than that of helium gas. Additionally, argon gas has a lower mobility than helium gas.

The third gas may include only pure argon gas. Alternatively, the third gas may include a mixture gas of argon and helium.

After the third gas including argon gas is supplied into the chamber 110, the high-frequency power source 160 may apply a third energy to the showerhead 130. When argon gas is used exclusively as the third gas, the third energy applied to the showerhead 130 may be substantially equal to or higher than an ionization energy of argon gas. For example, when argon gas is used as the third gas, the third energy applied to the showerhead 130 may be substantially equal to or higher than 1,520 kJ/mol or 15.75 eV, corresponding to the ionization energy of argon gas.

When the third gas includes a mixture gas of argon and helium, the third energy applied to the showerhead 130 may be substantially equal to or higher than an ionization energy of helium gas. For example, the third energy applied to the showerhead 130 may be substantially equal to or higher than 2,372 kJ/mol or 24.6 eV, corresponding to the ionization energy of helium gas. At S210, a plasma region may be formed in the chamber 110 by the third energy applied to the showerhead 130.

The third gas may have a lower ionization energy than the fourth gas, described later. Thus, the third gas may form the plasma region at a lower energy than an energy with which the plasma region may be formed by the fourth gas. Additionally, because the third gas includes a gas having a higher atomic weight than a gas included in the fourth gas, the third gas may have a lower mobility than the fourth gas while forming plasma. Thus, damage to the wafer (W) generated by plasma while forming the plasma region when using the third gas may be lower than when using the fourth gas. Because the damage to the wafer (W) may be caused when the plasma region is formed, the damage to the wafer (W) may be reduced.

In an example embodiment of the present invention, the third energy may be applied to the showerhead 130 before the third gas is supplied into the chamber 110. In another example embodiment of the present invention, the third energy may be applied to the showerhead 130 at the same time the third gas is supplied into the chamber 110.

When completing the plasma region in the chamber 110, a fourth gas including helium gas may be supplied into the chamber 110 through the showerhead 130 from the second gas source 150.

Pure helium gas may be used as the fourth gas. Alternatively, a mixture gas of argon gas and helium gas may be used as the fourth gas. When the fourth gas includes a mixture gas of argon gas and helium gas, more argon gas may be included in the third gas than in the fourth gas, and more helium gas may be included in the fourth gas than in the third gas.

When the fourth gas is supplied into the chamber 110 and the first energy is applied to the showerhead 130 to a degree that is substantially equal to or higher than the ionization energy of the fourth gas, the fourth gas may achieve a plasma state.

When helium gas is used as the fourth gas, the third energy applied to the showerhead 130 may be substantially equal to or higher than the ionization energy of helium gas. For example, the third energy applied to the showerhead 130 may be substantially equal to or higher than 2,372 kJ/mol or 24.6 eV corresponding to the ionization energy of helium gas.

When the mixture gas of argon and helium is used as the fourth gas, the third energy applied to the showerhead 130 may be substantially equal to or higher than the ionization energy of helium gas included in the mixture gas of argon and helium. For example, the third energy applied to the showerhead 130 may be substantially equal to or higher than 2,372 kJ/mol or 24.6 eV, corresponding to the ionization energy of helium gas, which has a lower atomic weight than argon gas.

Because the third gas is in the plasma state, even though the third energy is lower than the ionization energy of the fourth gas, the fourth gas may achieve the plasma state. Therefore, the third energy applied to the showerhead 130 may be higher than the ionization energy of the third gas and lower than the ionization energy of the fourth gas.

However, when the fourth gas is supplied into the chamber 110 and the third energy is applied to the showerhead 130 to a degree that is substantially equal to or higher than the ionization energy of the third gas but lower than the ionization energy of the fourth gas, the fourth gas may not achieve a plasma state.

In such a case, the high-frequency power source 160 applies a fourth energy that is substantially equal to or higher than the ionization energy of the fourth gas to the showerhead 130.

In an example embodiment of the present invention, the fourth energy may be applied to the showerhead 130 before the fourth gas is supplied to the chamber 110. In another example embodiment of the present invention, the fourth energy may be applied to the showerhead 130 at the same time the fourth gas is supplied to the chamber 110.

When helium gas is used as the fourth gas, the fourth energy may be applied to the showerhead 130 to a degree that is substantially equal to or higher than the ionization energy of helium gas. For example, the fourth energy may be applied to the showerhead 130 to a degree that is substantially equal to or higher than 2,372 kJ/mol or 24.6 eV, corresponding to the ionization energy of helium gas.

When the mixture gas of argon and helium is used as the fourth gas, the fourth energy may be applied to the showerhead 130 to a degree that is substantially equal to or higher than the ionization energy of helium gas included in the mixture gas of argon and helium. For example, the fourth energy may be applied to the showerhead 130 to a degree that is substantially equal to or higher than 2,372 kJ/mol or 24.6 eV, corresponding to the ionization energy of helium gas.

At S220, the fourth gas may be converted to the plasma state by the third energy applied or the fourth energy applied to the showerhead 130, and then maintains the plasma region uniformly.

The ionization energy of the fourth gas may be higher than that of the third gas, but, while forming plasma, the fourth gas may have a higher mobility than the third gas, because the fourth gas may have a lower atomic weight than the third gas. Therefore, the fourth gas may maintain the plasma region uniformly.

The third gas and the fourth gas may be supplied into the chamber 110 with a flow rate ratio of approximately 1.0:1.1 to approximately 1:2. In an example embodiment of the present invention, the third gas and the fourth gas may be supplied into the chamber 110 with a flow rate ratio of approximately 1.0:1.2 to approximately 1.0:1.3.

At S230, when the plasma region is formed and then is uniformly maintained, a source gas for depositing a layer is supplied into the chamber 110. The layer is deposited on the wafer (W) using the source gas.

For example, the first gas source 140 supplies titanium tetrachloride (TiCl₄) gas to the chamber 110, and the second gas source 150 supplies hydrogen (H₂) gas to the chamber 110. The titanium tetrachloride (TiCl₄) gas and the hydrogen (H₂) gas may be supplied into the chamber 110 with a flow rate ratio of approximately 1:300 to approximately 1:400. In an example embodiment of the present invention, the titanium tetrachloride (TiCl₄) gas and the hydrogen (H₂) gas may be supplied into the chamber 110 with a flow rate ratio of approximately 1:330 to approximately 1:340. The titanium tetrachloride (TiCl₄) gas may react with the hydrogen (H₂) gas in the plasma region to form a titanium (Ti) layer on the wafer (W).

In an example embodiment of the present invention, the source gas may be supplied into the chamber 110 at the same time the third gas is supplied into the chamber 110. In another example embodiment of the present invention, the source gas may be supplied into the chamber 110 at the same time the fourth gas is supplied into the chamber 110.

At S240, a gas including nitrogen is supplied into the chamber 110 in which the plasma region may be uniformly maintained. The layer deposited on the wafer (W) may be nitrided using the gas including nitrogen.

For example, the second gas source 150 supplies hydrogen gas and ammonia gas into the chamber 110. The hydrogen gas and the ammonia gas may be supplied into the chamber 110 with a flow rate ratio of approximately 1.0:1.5 to approximately 1.0:1.8. In an example embodiment of the present invention, the hydrogen gas and the ammonia gas may be supplied into the chamber 110 with a flow rate ratio of approximately 1.0:1.8 to approximately 1:2. A surface of the titanium layer formed on the wafer (W) may be converted to a titanium nitride layer. Therefore, a double layer including the titanium layer and the titanium nitride layer is formed on the wafer (W).

According to example embodiments of the present invention, after the plasma region is formed using the third gas having a relatively lower ionization energy than the fourth gas, the plasma region may be uniformly maintained using the fourth gas, which has a relatively higher mobility than the third gas. Therefore, damage to the wafer (W) caused by plasma in the formation of the plasma region may be reduced; thus, the wafer (W) may be spared the damage caused by the plasma, because most of the damage to the wafer (W) by plasma is caused in the formation of the plasma region.

Hereinafter, a method of forming the double layer including the titanium layer and the titanium nitride layer using the above-described method of forming plasma will be illustrated.

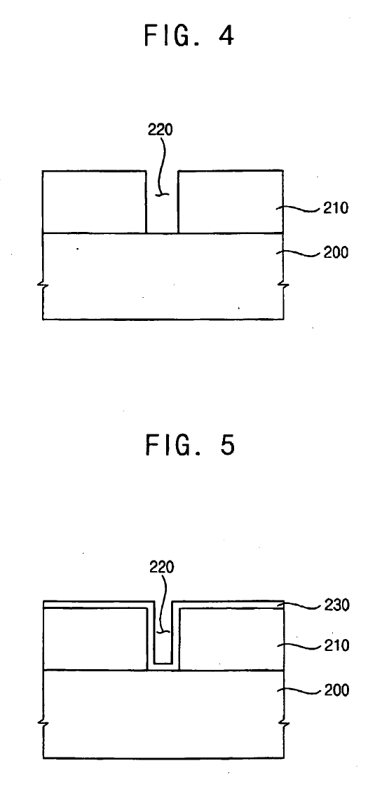

FIGS. 4 and 5 are cross-sectional views illustrating processing for a method of forming a double layer comprising titanium and titanium nitride.

Referring to FIG. 4, an insulating interlayer (not shown) may be formed on a semiconductor substrate 200 and may be patterned by a photolithography process to thereby form an insulating interlayer pattern 210 having an opening 220 through which a surface of the semiconductor substrate 200 is partially exposed.

The opening 220 may be provided for an electrical connection between the substrate 200 and a conductive structure (not shown) on or over the substrate 200. For example, a plug for electrically connecting the substrate 200 to a bit line (not shown) or a lower electrode (not shown) may be formed in the opening 220.

Referring to FIG. 5, a double layer 230 including a titanium layer and a titanium nitride layer may be formed by performing the following processes.

A plasma region may be formed by supplying a first gas including argon onto a surface of the insulating interlayer pattern 210, a sidewall of the opening 220, and a lower face of the opening 220 at a first flow rate. The plasma region may be maintained by supplying a gas including helium at a second flow rate. In an example embodiment of the present invention, the gas including helium may be a mixture gas of argon and helium, and the second flow rate may be higher than the first flow rate. A titanium tetrachloride layer may be formed by supplying a source gas such as titanium tetrachloride (TiCl₄) gas and hydrogen (H₂) gas. The titanium tetrachloride (TiCl₄) layer is nitrided by supplying ammonia (NH₃) gas and hydrogen (H₂) gas, etc.

While plasma may be formed in the chamber using argon gas, which has ionization energy relatively lower than helium gas, damage to the wafer (W) caused by plasma in the formation of the plasma region may be reduced; thus, the wafer (W) may be less likely to be damaged by plasma.

Further, the plasma region may be maintained using helium gas which has greater mobility than argon gas, so that uniformity of the titanium layer may be sufficiently improved.

### Evaluation of Plasma Damage and Deposition Distribution

### COMPARATIVE EXPERIMENTAL EXAMPLE 1

TABLE 1

| | | | Maintenance/ | | | | | |
|---|---|---|---|---|---|---|---|---|
| | Formation of | | Deposition of | | | | Plasma Damage | Deposition |
| | Plasma Region | | Plasma Region | | Nitridation | | Voltage (Vpdm) | Distribution |
| TiCl₄ Flow Rate | — | | 12 | sccm | — | | 1.204 V | 6% |
| Ar Flow Rate | 1,600 | sccm | 1,600 | sccm | 1,600 | sccm | | |
| H₂ Flow Rate | — | | 4,000 | sccm | 2,000 | sccm | | |
| NH₃ Flow Rate | — | | — | | 1,500 | sccm | | |
| RF Power | 800 | W | 800 | W | 1,200 | W | | |

Table 1 shows results and experimental conditions of comparative experimental example 1 in accordance with a conventional process at high power. In comparative experimental example 1, the plasma region was formed in the chamber by applying a high-frequency power of about 800 W to the chamber, which only includes pure argon (Ar) gas, and uniformity of the plasma region was maintained by using the pure argon (Ar) gas. Then, titanium tetrachloride (TiCl₄) gas and hydrogen (H₂) gas were supplied into the chamber in which a wafer was positioned, so that a titanium layer was formed on the wafer. Thereafter, ammonia (NH₃) gas was supplied into the chamber and a high-frequency power of approximately 1,200 W was applied to the chamber, so that the titanium layer on the wafer was nitrided in the chamber. Plasma in the chamber caused damage to the wafer by as much as a measured result of approximately 1.204V and deposition distribution of the titanium layer, which shows a degree of difference between a thickness of a central portion of the titanium layer deposited on the wafer and that of a peripheral portion of the titanium layer deposited on the wafer, was about 6%, as listed in Table 1.

### COMPARATIVE EXPERIMENTAL EXAMPLE 2

TABLE 2

| | | | Maintenance/ | | | | | |
|---|---|---|---|---|---|---|---|---|
| | Formation of | | Deposition of | | | | Plasma Damage | Deposition |
| | Plasma Region | | Plasma Region | | Nitridation | | Voltage (Vpdm) | Distribution |
| TiCl₄ Flow Rate | — | | 12 | sccm | — | | 0.483 V | 16% |
| Ar Flow Rate | 1,600 | sccm | 1,600 | sccm | 1,600 | sccm | | |
| H₂ Flow Rate | — | | 4,000 | sccm | 2,000 | sccm | | |
| NH₃ Flow Rate | — | | — | | 1,500 | sccm | | |
| RF Power | 350 | W | 350 | W | 600 | W | | |

Table 2 shows results and experimental conditions of comparative experimental example 2 in accordance with a conventional process at low power. In comparative experimental example 2, after forming a plasma region and maintaining the plasma region by supplying only argon gas to a chamber to which a high-frequency power of about 350 W was applied, a titanium layer was formed on a wafer by supplying titanium tetrachloride (TiCl₄) gas and hydrogen (H₂) gas to the chamber. When the titanium layer was formed on the wafer, the titanium layer was nitrided by applying a high-frequency power of about 600 W to the chamber and supplying ammonia (NH₃) gas. A measured result of plasma damage on the wafer in accordance with comparative experimental example 2 was about 0.483V, and a measured result of deposition distribution was approximately 16%. As compared with comparative experimental example 1, the high-frequency power for a formation of the plasma region was reduced to about 350 W from about 800 W, and the high-frequency power for nitridation of the titanium layer was reduced to about 600 W from approximately 1,200 W. The results of comparative experimental example 2 show that the above power reduction decreased damage to the wafer caused by plasma from approximately 1.204V to about 0.483V compared with the results of comparative experimental example 1. However, the above power reduction also increased the deposition distribution of the titanium layer from about 6% to approximately 16% compared to the results of comparative experimental example 1, so that the deposition distribution of the titanium layer was deteriorated due to the power reduction and a central portion of the titanium layer on the wafer had a greater thickness than a peripheral portion thereof. The power reduction for minimizing the damage to the wafer was reported to deteriorate uniformity of plasma on the wafer, and as a result, the titanium layer was non-uniformly formed on the wafer, to thereby deteriorate the deposition distribution of the titanium layer in comparative experimental example 2.

### EXPERIMENTAL EXAMPLE

TABLE 3

| | | | Maintenance/ | | | | | |
|---|---|---|---|---|---|---|---|---|
| | Formation of | | Deposition of | | | | Plasma Damage | Deposition |
| | Plasma Region | | Plasma Region | | Nitridation | | Voltage (Vpdm) | Distribution |
| TiCl₄ Flow Rate | — | | 12 | sccm | — | | 0.472 V | 7% |
| He Flow Rate | — | | 800 | sccm | 800 | sccm | | |
| Ar Flow Rate | 1,600 | sccm | 1,200 | sccm | 1,200 | sccm | | |
| H₂ Flow Rate | — | | 4,000 | sccm | 2,000 | sccm | | |
| NH₃ Flow Rate | — | | — | | 1,500 | sccm | | |
| RF Power | 350 | W | 350 | W | 600 | W | | |

Table 3 shows results of an experimental example. In the experimental example, a plasma region was formed by supplying only argon gas to a chamber to which a high-frequency power of about 350 W was applied and maintaining the plasma region by simultaneously supplying both argon gas and helium gas, a titanium layer was formed on a wafer by supplying titanium tetrachloride (TiCl₄) gas and hydrogen (H₂) gas to the chamber. When the titanium layer was formed on the wafer, the titanium layer was nitrided by applying a high-frequency power of about 600 W to the chamber and supplying ammonia (NH₃) gas. A measured result of plasma damage on the wafer in accordance with the experimental example was about 0.472V, and deposition distribution was about 7%. In the experimental example, the deposition was performed after using argon gas to form the plasma region. Argon gas has a relatively lower ionization energy than helium gas, and adding helium gas, which has better mobility than argon gas, to the plasma region, to maintain the plasma region uniformly. Hence, the plasma damage in the experimental example decreased slightly from about 0.483V to about 0.472V compared with the plasma damage in comparative experimental example 2. Additionally, the deposition distribution in the experimental example improved from approximately 16% to about 7%, compared with the deposition distribution in the comparative experimental example 2. Therefore, when the plasma region is formed using argon gas of which has a relatively lower ionization energy than helium gas, and a deposition process is performed in a state in which the plasma region is maintained using helium gas, which has a better mobility than argon gas, the plasma damage may be reduced, and simultaneously, deposition of a layer may be performed uniformly.

As illustrated above, in a method of forming plasma and a method of forming a layer using plasma in accordance with an example embodiment of the present invention, the plasma region may be formed using an inert gas, which has a relatively low ionization energy, and the plasma region may be maintained using an inert gas, which has a relatively good mobility. Therefore, the plasma damage may be reduced, and when the deposition of the layer is performed using plasma included in the plasma region, the layer may be deposited uniformly.

The foregoing is illustrative of example embodiments of the present invention and is not to be construed as limiting thereof. Although example embodiments of this invention have been described, those skilled in the art will readily appreciate that many modifications are possible in the example embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of forming plasma comprising:
forming a plasma region in a sealed space by supplying a plasma source gas into the sealed space at a first flow rate, the plasma source gas including a first gas having a first atomic weight; and
maintaining the plasma region by supplying a plasma maintenance gas into the sealed space at a second flow rate higher than the first flow rate, the plasma maintenance gas including a second gas having a second atomic weight lower than the first atomic weight.

2. The method of claim 1, wherein the first gas includes any one selected from the group consisting of neon, argon, krypton, xenon and radon, and the second gas includes any one selected from the group consisting of helium, neon, argon, krypton and xenon, such that the first and the second gases are different from each other.

3. The method of claim 2, wherein the plasma maintenance gas further includes a third gas substantially the same as the first gas.

4. The method of claim 2, wherein the plasma maintenance gas further includes a third gas that is different from the first gas and has a third atomic weight lower than the first atomic weight of the first gas, and the third gas includes at least one selected from the group consisting of helium, neon, argon, krypton and xenon.

5. The method of claim 4, wherein the plasma maintenance gas further includes a fourth gas substantially the same as the first gas.

6. The method of claim 2, wherein the plasma source gas further includes a third gas substantially the same as the second gas.

7. The method of claim 2, wherein the plasma source gas further includes a third gas that is different from the second gas and has a third atomic weight higher than the second atomic weight of the second gas, and the third gas includes at least one selected from the group consisting of neon, argon, krypton, xenon and radon.

8. The method of claim 7, wherein the plasma source gas further includes a fourth gas substantially the same as the second gas.

9. The method of claim 2, wherein the plasma source gas further includes a third gas that is substantially the same as the second gas or has an atomic weight higher than that of the second gas and includes at least one selected from the group consisting of helium, neon, argon, krypton, xenon and radon, and wherein the plasma maintenance gas further includes a fourth gas that is substantially the same as the first gas or has an atomic weight lower than the first atomic weight of the first gas, and includes at least one selected from the group consisting of helium, neon, argon, krypton, xenon and radon.

10. The method of claim 9, wherein the plasma source gas includes a first mixture gas and the plasma maintenance gas includes a second mixture gas, and the first and the second mixture gases include substantially the same components therein at respective mixture ratios different from each other.

11. The method of claim 10, wherein the plasma source gas includes more of the second gas than the plasma maintenance gas.

12. The method of claim 1, wherein a flow rate ratio of the first flow rate to the second flow rate is in a range of approximately 1:1.1 to approximately 1:2.

13. The method of claim 1, further comprising supplying a source gas for wafer processing into the sealed space.

14. The method of claim 13, wherein the source gas for the wafer processing is supplied at the same time as the plasma source gas is supplied.

15. The method of claim 13, wherein the source gas for the wafer processing is supplied at the same time as the plasma region is formed.

16. The method of claim 13, wherein the source gas for the wafer processing is supplied in a state in which the plasma region is maintained.

17. The method of claim 13, wherein the source gas for the wafer processing includes an etching gas for etching a layer formed on a wafer.

18. The method of claim 13, wherein the source gas for the wafer processing is a deposition gas for forming a layer on a wafer by a deposition process.

19. The method of claim 13, wherein the source gas for the wafer processing is a cleaning gas for removing contaminants from a wafer.

20. The method of claim 1, wherein energy applied into the sealed space while forming the plasma region is substantially equal to energy applied into the sealed space while maintaining the plasma region.

21. The method of claim 1, wherein energy applied into the sealed space while forming the plasma region is lower than energy applied into the sealed space while maintaining the plasma region.

22. A method of forming a layer comprising:
forming a plasma region in a sealed space by supplying a first gas into the sealed space with a first flow rate, the first gas including argon;
maintaining the plasma region by supplying a second gas into the sealed space with a second flow rate higher than the first flow rate, the second gas including helium; and
forming a layer on a wafer by supplying a source gas into the sealed space.

23. The method of claim 22, wherein the second gas further comprises argon.

24. The method of claim 22, wherein the first gas further comprises helium.

25. The method of claim 22, wherein the first gas further comprises helium, and wherein the second gas further comprises argon.

26. The method of claim 25, wherein the second gas includes more helium than the first gas.

27. The method of claim 22, wherein a flow rate ratio of the first gas to the second gas ranges from approximately 1.0:1.1 to approximately 1:2.

28. The method of claim 22, wherein the source gas includes titanium tetrachloride (TiCl₄) gas and hydrogen (H₂) gas.

29. The method of claim 28, wherein a flow rate ratio of titanium tetrachloride (TiCl₄) gas to hydrogen (H₂) gas ranges from approximately 1:300 to approximately 1:400.

30. The method of claim 22, wherein energy applied into the sealed space while forming the plasma region is substantially equal to energy applied into the sealed space while maintaining the plasma region.

31. The method of claim 22, wherein energy applied into the sealed space while forming the plasma region is lower than energy applied into the sealed space while maintaining the plasma region.

32. The method of claim 22, further comprising nitriding the layer formed on the wafer by supplying a gas including nitrogen to the sealed space.
